(19) United States
(12) Patent Application Publication
(10) Pub. No.: US 2011/0060522 A1
(43) Pub. Date: Mar. 10, 2011

(54) Apparatus and method for providing location information service in portable terminal

(75) Inventors: Ji-Heon Oh, Yongin-si (KR); Hyun-Su Hong, Seongnam-si (KR); Gye-Joong Shin, Seongnam-si (KR); Sung-Min Park, Seongnam-si (KR); Chan-Hyoung Park, Seoul (KR)

(73) Assignee: Samsung Electronics Co., Ltd., Suwon-si (KR)

(21) Appl. No.: 12/807,679

(22) Filed: Sep. 10, 2010

(30) Foreign Application Priority Data
Sep. 10, 2009 (KR) 10-2009-0085249

(51) Int. Cl. G01C 21/12

(52) U.S. Cl. 701/217

(57) ABSTRACT

An apparatus and method provides a location information service in a portable terminal when the predicted location is reliable. The apparatus includes a validity determiner for, by a moving pattern of a user, determining the validity of location information previously predicted using Pedestrian Dead Reckoning (PDR) information.

### CROSS-REFERENCE TO RELATED APPLICATION(S) AND CLAIM OF PRIORITY

This application claims priority under 35 U.S.C. §119(a) of a Korean patent application filed in the Korean Intellectual Property Office on Sep. 10, 2009 and assigned Serial No. 10-2009-0085249, the entire disclosure of which is hereby incorporated by reference.

### TECHNICAL FIELD OF THE INVENTION

The present invention relates to an apparatus and method for providing location information in a portable terminal. More particularly, the present invention relates to an apparatus and method for, when the portable terminal enters a shadow area in the course of providing location information, determining a moving pattern of a user and determining whether there is an error between information on the shadow area and a current location of the portable terminal, thus improving the accuracy of the location information.

### BACKGROUND OF THE INVENTION

In recent years, the use of portable terminals has suddenly spread due to their convenience of carrying. Thus, service providers (i.e., terminal manufacturers) are competitively developing the portable terminals that provide more convenient functions to secure many users.

For example, the portable terminals are providing functions of a phone book, a game, a scheduler, a Short Message Service (SMS), a Multimedia Message Service (MMS), a Broadcast Message Service (BMS), an Internet service, an electronic mail (e-mail) message, a morning wakeup call, MPEG-1 Audio Layer 3 (MP3), a digital camera, and so forth.

Also, the portable terminal may provide a navigation function by receiving a satellite signal, providing traffic information in connection with a traffic information center through a mobile communication network, or providing information on a specific route to a user.

The above navigation function, which is a function of storing map data, receiving a satellite signal, and displaying a current mobile location, needs to keep receiving a satellite signal. When the portable terminal enters a shadow area that is not capable of receiving a satellite signal, in order to keep providing location information to a user, the portable terminal estimates a new location within the shadow area, on the basis of the last valid location acquired before shadow area entry, using Pedestrian Dead Reckoning (PDR) information. Until passing through the shadow area or, in other words, until reception of a satellite signal is made possible, the portable terminal provides location information to the user on the basis of the PDR information or, from after a pedestrian enters the shadow area, the portable terminal provides restricted location information to the user based on a defined time and distance.

When providing location information using PDR information in a shadow area, because the portable terminal does not reflect a change of the surrounding environment such as when the user of the portable terminal moves indoors and takes an elevator, the portable terminal estimates erroneous location information.

For one example, when the user of the portable terminal takes an elevator after entering a shadow area, although the portable terminal is not in movement, the portable terminal will provide the user with previously predicted location information, i.e., erroneous information that the portable terminal is in movement.

### SUMMARY OF THE INVENTION

To address the above-discussed deficiencies of the prior art, one aspect of the present invention is to substantially solve at least the above problems and/or disadvantages and to provide at least the advantages below. Accordingly, one aspect of the present invention is to provide an apparatus and method for providing location information of an improved accuracy in a portable terminal.

Another aspect of the present invention is to provide an apparatus and a method for determining the accuracy of the location information for a shadow area in a portable terminal.

Yet another aspect of the present invention is to provide an apparatus and method for determining a moving pattern within a shadow area using a plurality of pieces of sensor information acquired before shadow area entry in a portable terminal.

The above aspects are achieved by providing an apparatus and method for providing a location information service in a portable terminal.

In accordance with an aspect of the present invention, an apparatus for providing a location information service in a portable terminal is provided. The apparatus includes a validity determiner for, by a moving pattern of a user, determining the validity of location information previously predicted using Pedestrian Dead Reckoning (PDR) information.

In accordance with another aspect of the present invention, a method for providing a location information service in a portable terminal is provided. The method includes determining, by a moving pattern of a user, the validity of location information previously predicted using PDR information.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a portable terminal providing a location information service according to an embodiment of the present invention;

FIG. 2 illustrates a process of providing location information in a portable terminal according to an embodiment of the present invention; and

FIG. 3 illustrates a process of providing location information in a portable terminal according to an embodiment of the present invention.

Throughout the drawings, like reference numerals will be understood to refer to like parts, components and structures.

### DETAILED DESCRIPTION OF THE INVENTION

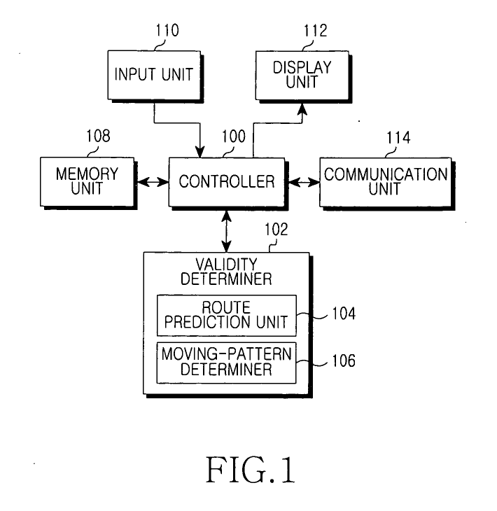

FIGS. 1 through 3, discussed below, and the various embodiments used to describe the principles of the present disclosure in this patent document are by way of illustration only and should not be construed in any way to limit the scope of the disclosure.

The following description is made for an apparatus and method for, in order to provide location information of an improved accuracy, determining a moving pattern within a shadow area using a plurality of pieces of sensor information acquired before shadow area entry in a portable terminal according to the present invention.

FIG. 1 illustrates a portable terminal providing a location information service according to an embodiment of the present invention.

As shown in FIG. 1, the portable terminal may include a controller 100, a validity determiner 102, a memory unit 108, an input unit 110, a display unit 112, and a communication unit 114. The validity determiner 102 can further include a route prediction unit 104 and a moving-pattern determiner 106. The portable terminal may include additional units. Similarly, the functionality of two or more of the above units may be integrated into a single component.

The controller 100 of the portable terminal controls a general operation of the portable terminal. For example, the controller 100 performs processing and control for voice call and data communication. In addition to the general function, in order to provide location information with improved accuracy according to the present invention when the portable terminal enters a shadow area, the controller 100 runs processes to determine the accuracy of the location information while in the shadow area.

To perform the above operation, the controller 100 determines a moving pattern of a user (i.e., a moving pattern of a portable terminal) within the shadow area, using a plurality of pieces of sensor information acquired before shadow area entry, and determines whether there is an error between a location moved in the determined moving pattern and a location previously predicted using Pedestrian Dead Reckoning (PDR) information, thus determining the validity of the location previously predicted using the PDR information.

In another embodiment, the controller 100 runs processes to determine the validity of the location information predicted through PDR information provided by a shadow area based on a situation (e.g., a building, a subway, an elevator, an escalator, and such) of the shadow area where the portable terminal moves.

Under the control of the controller 100, the validity determiner 102 runs processes to determine a moving pattern of a portable terminal entering a shadow area and predict location information of the portable terminal within the shadow area, and to determine an error between the predicted location and the location previously predicted using the PDR information and determine the validity of the location previously predicted using the PDR information.

Under the control of the validity determiner 102, the moving-pattern determiner 106 comprehends the moving pattern and surrounding environment of the portable terminal using information acquired through a plurality of sensors.

For example, the moving-pattern determiner 106 can determine a footstep of a user of the portable terminal using the information acquired from the sensors, determine a movement speed and a movement time using the determined footstep to estimate a pace of the user, and determine whether the user performs an actual walk, using the estimated pace.

When the portable terminal enters the shadow area, under the control of the validity determiner 102, the route prediction unit 104 predicts a movement location of the portable terminal using the PDR information acquired before entering the shadow area and, according to the present invention, the route prediction unit 104 determines whether a user performs an actual walk or the user does not perform the actual walk (e.g., the user moves using an elevator) through the moving-pattern determiner 106. When determining that the user does not perform the actual walk, the route prediction unit 104 processes to inform the validity determiner 102 that the location information of the portable terminal predicted using the PDR information has no validity.

The memory unit 108 includes, for example, a Read Only Memory (ROM), a Random Access Memory (RAM), a flash ROM, and such. The ROM stores a microcode (i.e., code) of a program for processing and controlling the controller 100 and the validity determiner 102 and a variety of kinds of reference data.

The RAM, a working memory of the controller 100, stores temporary data generated in execution of a variety of kinds of programs. The flash ROM stores a variety of updateable depository data such as a phone book, an outgoing message, an incoming message, and information of a user's touch input point. According to an embodiment of the present invention, the flash ROM stores information acquired through the plurality of sensors.

The input unit 110 includes numeral key buttons ‘0’ to ‘9’, a menu button, a cancel button, an OK button, a talk button, an end button, an Internet button, navigation key buttons, a plurality of function keys such as a character input key, and such. The input unit 110 provides key input data corresponding to a key pressed by a user to the controller 100.

The display unit 112 displays state information generated during operation of the portable terminal, a limited number of characters, a large amount of moving pictures and still pictures, and such. The display unit 112 can be a color Liquid Crystal Display (LCD), an Active Mode Organic Light Emitting Diode (AMOLED), and such. The display unit 112 includes a touch input device and thus, when applied to a portable terminal of a touch input scheme, the display unit 112 can be used as an input device.

The communication unit 114 performs a function of transmitting/receiving and processing a radio signal of data that is input/output through an antenna (not illustrated). For example, in a transmission mode, the communication unit 114 performs a function of processing original data through channel coding and spreading, converting the original data into a Radio Frequency (RF) signal, and transmitting the RF signal. In a reception mode, the communication unit 114 performs a function of converting a received RF signal into a baseband signal, processing the baseband signal through de-spreading and channel decoding, and restoring the signal to original data.

A role of the validity determiner 102 may be implemented by the controller 100 of the portable terminal. However, these are separately constructed and shown in the present invention as an example for description convenience, and never intend to limit the scope of the present invention. It shall be understood by those skilled in the art that various modifications of construction can be made within the scope of the present invention. For example, construction can also be such that all of them are processed in the controller 100.

The above description is made for an apparatus for, in order to provide location information of an improved accuracy, determining a moving pattern within a shadow area using a plurality of pieces of sensor information acquired before shadow area entry in a portable terminal according to the present invention. The following description is made for a method for, in order to provide location information of an improved accuracy, determining a moving pattern within a shadow area using the apparatus according to the present invention.

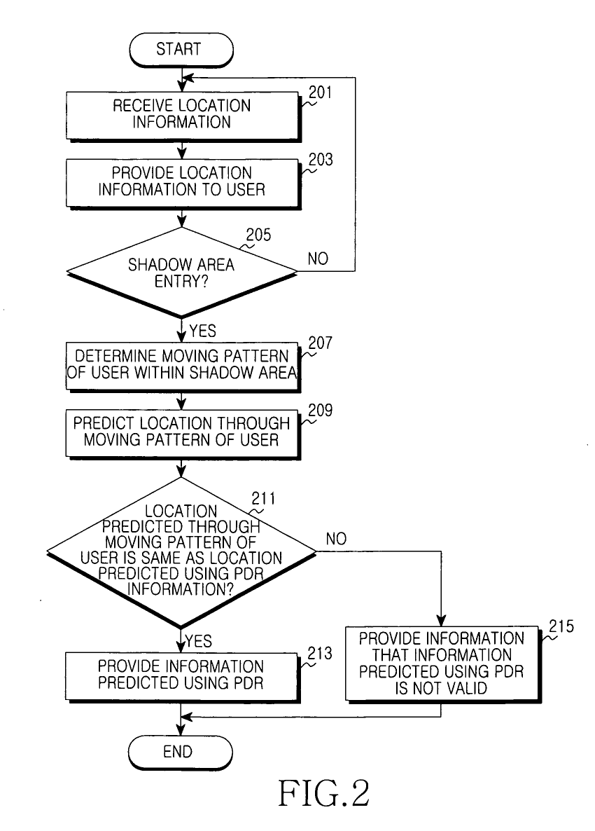

FIG. 2 illustrates a process of providing location information in a portable terminal according to an embodiment of the present invention.

As shown in FIG. 2, in block 201, the portable terminal receives location information. In block 203 the location information of the portable terminal is provided to a user.

In block 205, the portable terminal performs a process of determining whether the portable terminal enters a shadow area such that it is not capable of receiving the location information.

If the portable terminal does not enter the shadow area, the portable terminal returns to block 201 and processes to keep receiving the location information and provides the received location information to the user.

If the portable terminal enters the shadow area, the portable terminal proceeds to block 207 and determines a moving pattern of a user entering the shadow area. Also, when the portable terminal enters the shadow area, the portable terminal performs a general operation of predicting a user location through PDR information.

The portable terminal then performs a process of determining whether the location information in the shadow area is valid using the moving pattern of the user.

A way to determine whether location information in a shadow area is valid as above is as follows:

determining validity depending on whether a user performs an actual walk in the shadow area; and

determining validity through a comparison between a location predicted through PDR information and location information predicted according to a moving pattern of a user.

First, prior to determining validity through a comparison between a location predicted through PDR information and location information predicted according to a moving pattern of a user, the portable terminal proceeds to block 209 and performs a process of predicting a location of a user using a moving pattern of the user. Here, the portable terminal determines the moving pattern such as a user's gait and a use of other movement means (e.g., an elevator, and such).

In block 211, the portable terminal determines whether a location predicted through the PDR information is the same as the location predicted using the moving pattern of the user. That is, the portable terminal determines whether the user of the portable terminal is moving along a route predicted through the PDR information that was acquired before the portable terminal enters the shadow area.

If the location predicted through the PDR information is consistent with the location predicted using the moving pattern of the user, the portable terminal proceeds to block 213 and performs a general operation of the portable terminal of providing information predicted using the PDR.

On the other hand, if determining that the location predicted through the PDR information is not consistent with the location predicted using the moving pattern of the user, the portable terminal proceeds to block 215 and provides the user with a message that the information (i.e., the location predicted using the PDR information) has no validity, as the portable terminal does not actually move to the location predicted using the PDR information.

Second, when determining validity depending on whether a user performs an actual walk in a shadow area, the portable terminal may determine a situation (e.g., a building, a subway, an elevator, an escalator, and such) of the shadow area to which the portable terminal moves using sensor information acquired before shadow area entry and, if determining the situation of the shadow area, the portable terminal determines that location information of the shadow area previously predicted through PDR information has no validity. When determining the validity depending on whether the user performs the actual walk in the shadow area as above, the moving pattern of block 207 can be the situation of the shadow area.

After that, the portable terminal terminates the process according to an embodiment of the present invention.

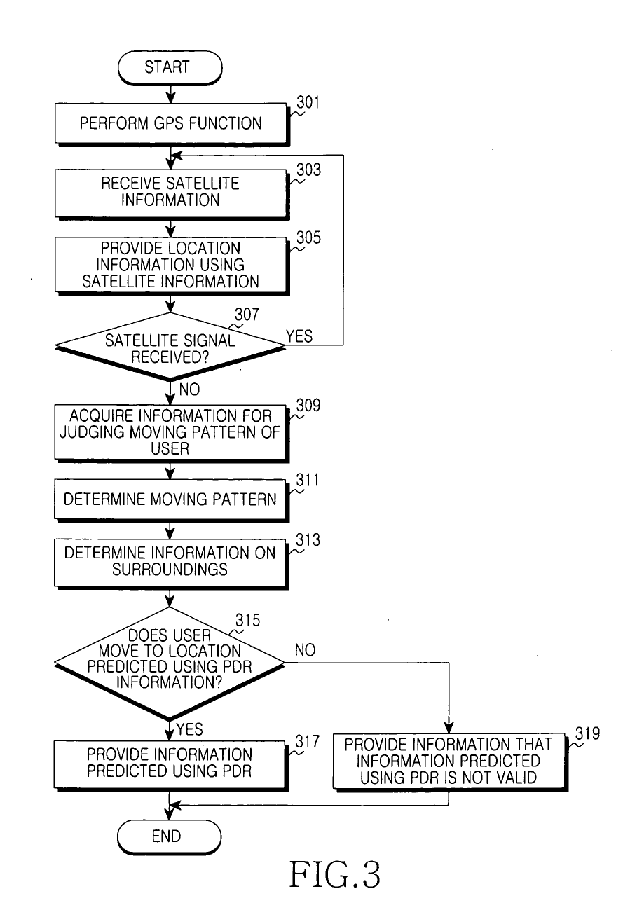

FIG. 3 illustrates a process of providing location information in a portable terminal according to an embodiment of the present invention.

FIG. 3, in block 301, the portable terminal performs a Global Positioning System (GPS) function. In block 303, the portable terminal performs a process of receiving satellite information.

In block 305, the portable terminal provides a general GPS service of providing location information of the portable terminal using the received satellite information.

Then, the portable terminal proceeds to block 307 and determines whether it receives a satellite signal. This is a process of determining whether the portable terminal enters a shadow area that is not capable of receiving a satellite signal in the course of performing the GPS function of providing location information.

If it receives the satellite signal, the portable terminal returns to block 303 and again performs a process of receiving satellite information.

Alternatively, if the portable terminal fails to receive the satellite signal upon entering the shadow area, the portable terminal proceeds to block 309 and, through a plurality of sensors, acquires information for determining a moving pattern of a user who enters the shadow area.

Here, the information for determining the moving pattern of the user is information for determining footstep information of the user (i.e., a pedestrian) of the portable terminal and can be, for example, azimuth information for magnetic north acquired from a geomagnetic sensor, angular velocity information acquired from a gyro sensor, current height information of the pedestrian acquired from a height sensor, and so forth. When the user moves while using the GPS function, the portable terminal can operate the plurality of sensors to acquire and store information dependent on a movement of the user.

In block 311, the portable terminal performs a process of determining a moving pattern including the user footstep, movement speed, footstep pattern, and such.

In detail, block 311 is a process of, when the portable terminal enters a shadow area, determining the user footstep using previously stored information acquired from the sensors, determining a movement speed and a movement time using the determined footstep to estimate a pace of a user, and determining whether the user performs an actual walk using the estimated pace. This is to prevent provision of erroneous information when the user does not perform an actual walk.

In block 313, the portable terminal performs a process of comprehending the surrounding environment of the user of the portable terminal located in the shadow area.

Here, the process of comprehending the surrounding environment is to determine information on the surroundings of the user of the portable terminal. The user of the portable terminal comprehends a situation such as when using a shadow area (i.e., a subway, an elevator, an escalator, and such).

For example, if entering a shadow area, the portable terminal can determine information on the surroundings such as when a user takes a subway or an elevator after entering the shadow area, by comparing a variance of data of a geomagnetic sensor with a variance of an integral value of data of a gyro sensor. At this time, if a value of the geomagnetic sensor greatly varies because of a magnetized object existing around the portable terminal, in order to reduce the occurrence of an error, the portable terminal estimates a pedestrian's advance direction using the data of the gyro sensor on the basis of previous valid data of the geomagnetic sensor.

In block 315, the portable terminal determines whether the user of the portable terminal moves to a location predicted through PDR information. Here, block 315 refers to a process of, if the portable terminal enters the shadow area, determining whether there is an error between a location predicted using valid data before the shadow area entry and a location predicted according to the moving pattern of the portable terminal according to the present invention.

If the portable terminal moves to the location predicted through the PDR information in block 315, the portable terminal proceeds to block 317 and performs a general operation of providing information predicted using the PDR.

Alternatively, if the portable terminal does not move to the location predicted through the PDR information in block 315, for example, if determining surroundings information such as the use of an elevator after entering the shadow area, the portable terminal proceeds to block 319 and provides the user with information that the information (i.e., the location predicted using the PDR information) has no validity as there occurs an error between the location predicted using the PDR information and the location predicted according to the moving pattern of the portable terminal.

After that, the portable terminal terminates the process according to an embodiment of the present invention.

As described above, the present invention is to provide location information of an improved accuracy in a portable terminal and, by determining a moving pattern within a shadow area using a plurality of pieces of sensor information acquired before shadow area entry, the present invention can provide more accurate location information than an existing portable terminal that provides limited location information irrespective of a change of a pedestrian's surrounding environment, a movement means, and such.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for providing a location information service in a portable terminal, the apparatus comprising
a validity determiner configured to determine the validity of a Pedestrian Dead Reckoning (PDR) location based on a moving pattern of a user, the PDR location comprising a location information predicted using Pedestrian Dead Reckoning (PDR) information.

2. The apparatus of claim 1, wherein the validity determiner determines the validity of the PDR location by using location information predicted according to at least one of a situation of a shadow area and the moving pattern of the user.

3. The apparatus of claim 2, wherein, when the user of the portable terminal does not perform an actual walk, the validity determiner determines the validity according to the situation of the shadow area by determining that there is no validity.

4. The apparatus of claim 2, wherein the validity determiner comprises a route prediction unit configured to predict the PDR location of the user and a moving pattern location of the user, the moving pattern location comprising a location predicted based on the moving pattern of the user, wherein the validity determiner determines the validity of the PDR location by comparing the PDR location with the moving pattern location.

5. The apparatus of claim 4, wherein the validity determiner further comprises a moving patter determiner configured to determine the moving pattern of the user using a plurality of pieces of sensor information acquired before entering a shadow area.

6. The apparatus of claim 5, wherein the moving pattern determiner determine the moving pattern of the user by determining whether the user performs an actual walk based on at least one of a pace of the user, a movement speed, and a footstep pattern.

7. The apparatus of claim 5, wherein the plurality of pieces of sensor information acquired before the shadow area entry comprises at least one of azimuth information, angular velocity information, and height information.

8. The apparatus of claim 7, further comprising a plurality of sensors configured to acquire the plurality of pieces of sensor information, the plurality of sensors comprising:
at least one geomagnetic sensor configured to acquire the azimuth information,
at least one gyro sensor configured to acquire the angular velocity information, and
at least one height sensor configured to acquire height information.

9. The apparatus of claim 2, wherein the shadow area is a location where the portable terminal is not capable of receiving a satellite signal in the course of performing a global positioning system function.

10. The apparatus of claim 4, wherein the validity determiner determines that the PDR location is valid when the PDR location and the moving pattern location are consistent.

11. A method for providing a location information service in a portable terminal, the method comprising
determining the validity of a Pedestrian Dead Reckoning (PDR) location based on a moving pattern of a user, the PDR location comprising location information predicted using Pedestrian Dead Reckoning (PDR) information.

12. The method of claim 11, wherein the validity of the PDR location based on the moving pattern of the user is determined by using location information predicted according to at least one of a situation of a shadow area and the moving pattern of the user.

13. The method of claim 12, wherein determining the validity by using the situation of the shadow area comprises:
determining whether the user of the portable terminal performs an actual walk; and
when the user does not perform the actual walk, determining that the PDR location is not valid.

14. The method of claim 12, wherein determining the validity of the PDR location based on the location information predicted according to the moving pattern of the user comprises:
determining the PDR location of the user;
determining a moving pattern location of the user, the moving pattern location comprising location information predicted using the moving pattern of the user; and
comparing the PDR location with the moving pattern location.

15. The method of claim 14, wherein the moving pattern of the user is determined using a plurality of pieces of sensor information acquired before entering the shadow area.

16. The method of claim 15, wherein the moving pattern of the user represents one of an actual walk situation and a non-walk situation determined based on at least one of a pace of the user, a movement speed, and a footstep pattern.

17. The method of claim 15, wherein the plurality of pieces of sensor information acquired before the shadow area entry comprises at least one of azimuth information, angular velocity information, and height information.

18. The method of claim 12, wherein the shadow area is a location where the portable terminal is not capable of receiving a satellite signal in the course of performing a global positioning system function

19. The method of claim 14, wherein the PDR location is invalid when the PDR location and the moving pattern are not consistent.

20. The method of claim 14, wherein PDR location is valid when the PDR location and the moving pattern location are consistent.
